(19) United States
(12) Patent Application Publication
(10) Pub. No.: US 2014/0036748 A1
(43) Pub. Date: Feb. 6, 2014

(54) UE INDICATIONS OF POWER MODE PREFERENCES

(71) Applicant: Research In Motion Limited, Waterloo (CA)

(72) Inventors: Biswaroop MUKHERJEE, Stittsville (CA); William Anthony GAGE, Stittsville (CA); Robert NOVAK, Stittsville (CA)

(21) Appl. No.: 13/622,436

(22) Filed: Sep. 19, 2012

Related U.S. Application Data
(60) Provisional application No. 61/678,905, filed on Aug. 2, 2012.

(51) Int. Cl. H04W 52/02

(52) U.S. Cl. CPC H04W 52/0212
USPC 370/311

(57) ABSTRACT

The present disclosure relates generally to low traffic or power modes for a User Equipment (UE) or mobile or wireless device in wireless communications systems, and more particularly to indications provided by a UE to a communications network relating to state transitions of the UE in a power mode. A method in a UE is provided comprising: generating a power mode state preference to extend or change the current power mode state of the UE; and indicating to a network element the power mode state preference. The power mode state transition of the UE can involve turning a reception capability of the UE from an On state to an Off state and vice versa. The UE preference can be based on information within the UE, including on information from one or more applications on the UE.

### FIELD OF THE DISCLOSURE

The present disclosure relates generally to power modes for a User Equipment (UE) or mobile or wireless device in wireless communications systems, and more particularly to indications provided by a UE to a communications network relating to the power mode state preferred by the UE.

### BACKGROUND

Some wireless technologies support one or more power modes in a user equipment (UE) or other wireless device or mobile device. One type of power mode involves the UE temporarily turning off its reception capability (e.g. its receiver) for the purpose of allowing the UE to conserve battery power. A power mode can also allow radio resources that were allocated to the UE to be released or to be retained for a period longer than the original allocation by the network.

An example of a power mode is discontinuous reception (DRX) in the 3rd Generation Partnership Project (3GPP) Evolved Universal Terrestrial Radio Access (E-UTRA), also known as Long Term Evolution (LTE). LTE is a wireless communication standard for high-speed data for mobile devices and is derived from Universal Mobile Telecommunication System (UMTS)/High-Speed Packet Access (HSPA), and Global System for Mobile Communications (GSM)/Enhanced Data rates for GSM Evolution (EDGE) network technologies.

The LTE standard provides for increased data rates compared to those achieved in UMTS and GSM. The increases can be in the order of several multiples, even up to or exceeding a factor of 50. Thus while the data rates increase significantly in LTE, the energy storage capacities of batteries of UEs including mobile devices has not grown at the same rate. Accordingly, power saving techniques in communications systems and UEs have been, and continue to be, developed and implemented in order to at least partially offset the increased power demands required to achieve the higher data rates and increased bandwidths.

### BRIEF DESCRIPTION OF THE DRAWINGS

The present disclosure will be better understood having regard to the drawings in which:

FIG. 1 is an example LTE network that may be used in association with the present embodiments;

FIG. 2 is a block diagram showing RRC states and state transitions in an LTE system;

FIG. 3 is an example timing diagram of a UE showing the receiver status of the UE as well as packet activity to and from the UE;

FIG. 4A is an example timing diagram of a UE showing a postponement of a transition from a DRX On state to a DRX Off state;

FIG. 4B is an example timing diagram of a UE showing a postponement of a transition in a UE from a DRX Off state to a DRX On state;

FIG. 4C is an example timing diagram of a UE showing an advancement of a transition in a UE from a DRX Off state to a DRX On state;

FIG. 4D is an example timing diagram of a UE showing an advancement of a transition in a UE from a DRX On state to a DRX Off state;

FIG. 5 is a flow diagram of a process showing at least some of the steps at a UE when the UE signals a power mode state preference indication to a network in at least one embodiment of the present disclosure;

FIG. 6 is a flow diagram of a process showing at least some of the steps at a UE when the UE signals a power mode state preference indication to a network in another embodiment of the present disclosure;

FIG. 7 is an example timing diagram indicating the DRX state of a UE, the packet activity at the UE, and a DRX preference indication of the UE; and

FIG. 8 is an example UE that can be used in association with the teachings of the present disclosure.

### DETAILED DESCRIPTION

The present disclosure provides a method in a user equipment (UE), the method comprising: generating a power mode state preference to extend or change the current power mode state of the UE; and indicating to a network element the power mode state preference.

In one embodiment, the generating of the power mode state preference is based at least on a time of an upcoming scheduled power mode state change of the UE. In one embodiment the preference to extend the current power mode state is a preference to postpone the time of the upcoming scheduled power mode state transition, and wherein the preference to change the current power mode state of the UE is a preference to change the power mode of the UE before the upcoming scheduled power mode state change.

In a further embodiment, the method further comprises, after the indicating, receiving from the network element a power mode state indication indicating a power mode state for the UE based at least on the power mode preference of the UE. In one embodiment the method further comprises, after the receiving, implementing the indicated power mode state at the UE. In one embodiment the power mode state indication indicates one of an acceptance and a rejection of the power mode state preference of the UE.

In a further embodiment, the method further comprises, after the indicating, tracking a response time window in which the UE expects a power mode state indication from the network element indicating a power mode state based at least on the power mode state preference of the UE. In one embodiment, if the UE does not receive the power mode state indication from the network element within the response time window, the UE interprets the non-response as a rejection of its power mode state preference. In one embodiment the tracking involves using a timer to track the response time window.

In a further embodiment, a power mode state change of the UE involves one of: turning a reception capability of the UE from an On state to an Off state; and turning the reception capability of the UE from an Off state to an On state. In one embodiment the turning of the reception capability of the UE between On and Off states involves turning a receiver of the UE on and off, respectively.

In a further embodiment, the power mode state preference of the UE is based on information located on UE. In one embodiment the information within the UE comprises at least one of: a status of one or more applications on the UE; whether the UE expects to be receiving data from a network; a battery energy level of the UE; a value of one or more timers in the UE; a state of an interaction with a user; a current state of a transaction of the UE with a remote communicator; and an estimated round trip time associated with an expected response from a remote communicator. In one embodiment, whether the UE is expecting to receive data from a network includes whether one or more applications on the UE is expecting to receive data from the network. In one embodiment, when the information within the UE comprises whether the UE expects to be receiving data, if the UE is not expecting to receive data, the power mode state preference of the UE is, if a reception capability of the UE is in the On state, to turn the reception capability to the Off state, and if the reception capability of the UE is in the Off state, to maintain the reception capability in the Off state. In one embodiment, when the information within the UE comprises whether the UE expects to be receiving data, if the UE is expecting to receive data, the power mode state preference of the UE is, if a reception capability of the UE is in the Off state, to turn the reception capability to the On state, and if the reception capability of the UE is in the On state, to maintain the reception capability in the On state.

In a further embodiment the indicating step is performed by a one of: sending a message from the UE to the network element over a physical channel; sending a control element within a medium access control (MAC) message; and sending an information element with a Radio Resource Control (RRC) message from the UE to the network element. In one embodiment the physical channel is a physical uplink control channel (PUCCH).

In a further embodiment the UE and the network element are in a Long Term Evolution communications system. In a further embodiment the power mode state is a discontinuous reception (DRX) power mode state in a (DRX) scheme. In a further embodiment the UE is prohibited from indicating one or more additional power mode state preference indications for the duration of an indication prohibit time window following a power mode state change of the UE. In one embodiment the indication prohibit time window is configured by the network element through a one of: radio resource configuration (RRC) signalling, and a system information broadcast (SIB) by the network.

In a further embodiment, the UE is prohibited from indicating one or more additional power mode state preference indications during the response time window.

In one embodiment the UE is prohibited from indicating one or more additional power mode state preference indications for the duration of a preference indication lockout time window when the UE has not received responses from the network element to a defined number of previous consecutive preference indications. In one embodiment the preference indication lockout time window is configured by the network element through a one of: radio resource configuration (RRC) signalling, and a system information broadcast (SIB) by the network element. In one embodiment the indicating is performed by way of a PUCCH format type 1 message, and wherein the presence of the PUCCH format type 1 message from the UE indicates a preference of the UE to change the current power mode state of the UE. In one embodiment the indicating is performed by way of a PUCCH format type 1a message. In one embodiment a first bit in the message indicates a preference of one of two power mode states. In one embodiment a second bit in the message is for indicating a scheduling request (SR).

In a further embodiment the indicating is performed by way of a PUCCH format type 1b message. In one embodiment a first bit in the message indicates a preference of one of two power mode states. In one embodiment a second bit in the message is for indicating a scheduling request (SR).

In a further embodiment the indicating is performed by way of a PUCCH format type 2a message. In one embodiment a first bit in the message indicates a preference of one of two power mode states.

In a further embodiment the indicating is performed by way of a PUCCH format type 2b message. In one embodiment the message includes an indication for a scheduling request (SR), and the message further includes: a first bit in the message indicating a preference of one of two power mode configurations, and a second bit indicating a one of a preference for an immediate start of a short DRX cycle, and a preference for an immediate start of a long DRX cycle. In one embodiment the message includes an indication for a scheduling request (SR), and the message further includes: a first bit in the message indicating a preference of one of two power mode states, and a second bit in the message indicating a one of a preference for an immediate start of a short DRX cycle, and a preference for an immediate start of a long DRX cycle.

In a further embodiment the power mode state indication is received by way of a one of: a control element of a MAC message; and an information element of an RRC message.

In a further embodiment the power mode state indication is received over a physical downlink control channel (PDCCH) in the form of a downlink control information (DCI).

The present disclosure further provides a user equipment (UE) comprising: a communications subsystem adapted communicate with a network; memory; and a processor, wherein the user equipment is configured to: generate a power mode state preference to extend or change the current power mode state of the UE; and indicate to a network element the power mode state preference.

In one embodiment the generating of the power mode state preference is based at least on a time of an upcoming scheduled power mode state change of the UE. In one embodiment the preference to extend the current power mode state is a preference to postpone the time of the upcoming scheduled power mode state transition, and wherein the preference to change the current power mode state of the UE is a preference to change the power mode of the UE before the upcoming scheduled power mode state change.

In a further embodiment the user equipment is further configured to receive from the network element a power mode state indication indicating a power mode state for the UE based at least on the power mode preference of the UE. In one embodiment the user equipment is further configured to implement the indicated power mode state at the UE. In one embodiment the power mode state indication indicates one of an acceptance and a rejection of the power mode state preference of the UE.

In a further embodiment the user equipment is further configured to track a response time window in which the UE expects a power mode state indication from the network element indicating a power mode state based at least on the power mode state preference of the UE. In one embodiment if the UE does not receive the power mode state indication from the network element within the response time window, the UE interprets the non-response as a rejection of its power mode state preference. In one embodiment the tracking involves using a timer to track the response time window.

In a further embodiment, a power mode state change of the UE involves one of: turning a reception capability of the UE from an On state to an Off state; and turning the reception capability of the UE from an Off state to an On state. In one embodiment the turning of the reception capability of the UE between On and Off states involves turning a receiver of the UE on and off, respectively.

In a further embodiment, the power mode state preference of the UE is based on information located on UE. In one embodiment the information within the UE comprises at least one of: a status of one or more applications on the UE; whether the UE expects to be receiving data from a network; a battery energy level of the UE; a value of one or more timers in the UE; a state of an interaction with a user; a current state of a transaction of the UE with a remote communicator; and an estimated round trip time associated with an expected response from a remote communicator. In one embodiment, whether the UE is expecting to receive data from a network includes whether one or more applications on the UE is expecting to receive data from the network. In one embodiment, when the information within the UE comprises whether the UE expects to be receiving data, if the UE is not expecting to receive data, the power mode state preference of the UE is, if a reception capability of the UE is in the On state, to turn the reception capability to the Off state, and if the reception capability of the UE is in the Off state, to maintain the reception capability in the Off state. In one embodiment, when the information within the UE comprises whether the UE expects to be receiving data, if the UE is expecting to receive data, the power mode state preference of the UE is, if a reception capability of the UE is in the Off state, to turn the reception capability to the On state, and if the reception capability of the UE is in the On state, to maintain the reception capability in the On state.

In a further embodiment, the user equipment is further configured to indicate by a one of: sending a message from the UE to the network element over a physical channel; sending a control element within a medium access control (MAC) message; and sending an information element with a Radio Resource Control (RRC) message from the UE to the network element. In one embodiment the physical channel is a physical uplink control channel (PUCCH).

In a further embodiment, the UE and the network element are in a Long Term Evolution communications system. In a further embodiment the power mode state is a discontinuous reception (DRX) power mode state in a (DRX) scheme.

In a further embodiment, the UE is prohibited from indicating one or more additional power mode state preference indications for the duration of an indication prohibit time window following a power mode state change of the UE. In one embodiment the indication prohibit time window is configured by the network element through a one of: radio resource configuration (RRC) signalling, and a system information broadcast (SIB) by the network.

In a further embodiment, the UE is prohibited from indicating one or more additional power mode state preference indications during the response time window.

In a further embodiment the UE is prohibited from indicating one or more additional power mode state preference indications for the duration of a preference indication lockout time window when the UE has not received responses from the network element to a defined number of previous consecutive preference indications. In one embodiment the preference indication lockout time window is configured by the network element through a one of: radio resource configuration (RRC) signalling, and a system information broadcast (SIB) by the network element.

In a further embodiment the user equipment is further configured to indicate by way of a PUCCH format type 1 message, and wherein the presence of the PUCCH format type 1 message from the UE indicates a preference of the UE to change the current power mode state of the UE. In one embodiment the user equipment is further configured to indicate by way of a PUCCH format type 1a message. In one embodiment a first bit in the message indicates a preference of one of two power mode states. In one embodiment a second bit in the message is for indicating a scheduling request (SR).

In a further embodiment the user equipment is further configured to indicate by way of a PUCCH format type 1b message. In one embodiment a first bit in the message indicates a preference of one of two power mode states. In one embodiment a second bit in the message is for indicating a scheduling request (SR).

In a further embodiment the user equipment is further configured to indicate by way of a PUCCH format type 2a message. In one embodiment a first bit in the message indicates a preference of one of two power mode states. In one embodiment the user equipment is further configured to indicate by way of a PUCCH format type 2b message. In one embodiment the message includes an indication for a scheduling request (SR), and the message further includes: a first bit in the message indicating a preference of one of two power mode configurations, and a second bit indicating a one of a preference for an immediate start of a short DRX cycle, and a preference for an immediate start of a long DRX cycle. In one embodiment the message includes an indication for a scheduling request (SR), and the message further includes: a first bit in the message indicating a preference of one of two power mode states, and a second bit in the message indicating a one of a preference for an immediate start of a short DRX cycle, and a preference for an immediate start of a long DRX cycle.

In a further embodiment the power mode state indication is received by way of a one of: a control element of a MAC message; and an information element of an RRC message.

In a further embodiment the power mode state indication is received over a physical downlink control channel (PDCCH) in the form of a downlink control information (DCI).

The present disclosure further provides a method in a network element, the method comprising: receiving from a user equipment (UE) a power mode state preference to extend or change the current power mode state of the UE; and generating a power mode state indication for the UE based at least on the received power mode state preference of the UE. In one embodiment the method further comprises indicating to the UE the power mode state indication.

The present disclosure further provides a network element comprising: a communications subsystem adapted to receive a power mode state preference of a user equipment (UE) to extend or change the current power mode state of the UE; memory; and a processor, wherein the network element is configured to: receive from a user equipment (UE) a power mode state preference to extend or change the current power mode state of the UE; and generate a power mode state indication for the UE based at least on the received power mode state preference of the UE. In one embodiment the network element is further configured to indicate to the UE the power mode state indication.

In an LTE network, a Radio Resource Control (RRC) part of the protocol stack is responsible for the assignment, configuration and release of radio resources between the UE and the base station, an evolved universal terrestrial radio access network (E-UTRAN) node B (eNB). The UE can be in one of two modes, namely “idle mode” (RRC_Idle) or “connected mode” (RRC_Connected).

When in an LTE RRC connected mode, the UE can be in one of three states. These states are:

Continuous reception—The reception capability of the UE is turned on.

Short DRX—The UE only listens for downlink scheduling assignments periodically. In the intervals between listening, the UE turns off its reception capability.

Long DRX—Again, the UE only listens for downlink scheduling assignments periodically. In the intervals between listening, the UE turns off its reception capability. However, the frequency of the listening periods is typically lower than the listening frequency in a Short DRX state in order to conserve even more battery power of the UE.

In general terms, a DRX scheme involves a UE and a network negotiating phases or time periods in which data transfers can occur between the two. Outside of these phases or time periods, the UE can turn off its reception capability and enter a low power state. The turning off of its reception capability allows the UE to conserve battery power. While in a DRX mode, the UE will typically turn its reception capability on and off in a cyclical fashion. The network (e.g. base station) configures the duration of the receiver on and off periods that govern the DRX behavior and makes its transmission to the UE during periods that the reception capability is on (a “DRX On” period). A DRX On period followed by a “DRX Off” period, in which the reception capability is turned off, is a DRX cycle. Thus the terms DRX Off and DRX On are used to refer to the reception capability (e.g. receiver) of a UE being off, and on, respectively, when the UE is in a DRX state (e.g. Short DRX, Long DRX). Thus, for example, DRX On refers to a state in which the UE is in a DRX state and the receiver of the UE is turned on.

Once configured, the duration of the DRX On period and of the DRX Off period within a DRX cycle are constant until the next reconfiguration. For example, the DRX On period can be “x” milliseconds or subframes long and the DRX Off period can be “y” milliseconds or subframes long. When in a DRX mode, the UE typically runs continuously through DRX cycles.

Although a DRX cycle can conserve battery power in the UE, the UE is only able to receive data during the DRX On portion of each cycle since the reception capability is disabled during the DRX Off portion. Thus the UE can only receive data intermittently so that data throughput and responsiveness are therefore diminished. Accordingly, the temporary periodic disabling of the reception capability of the UE can present problems, such as poorer network performance and/or degradation in the perceived performance of one or more applications on the UE. Thus the power efficiency of the UE comes at the price of increased latency.

In some circumstances, the timing of the transitions or changes between the DRX On and DRX Off states can be inopportune and thus inefficient. The terms “transition” and “change” when referring to changes between power mode states of a UE, such as DRX On and DRX Off, are used interchangeably herein. An inefficient power mode state change may, for example, be caused by a mismatch between the DRX durations configured by the network and the timing of transactions or information exchanges initiated by applications running in the UE. For example, if the UE is in a DRX On state and is expecting to receive further data on a downlink channel in the very near future, the UE may nonetheless transition from the DRX On state to the DRX Off state because of the previously configured DRX On time. In other words, the UE may change power mode states due to a normal scheduled transition. The UE therefore has to wait until the next scheduled DRX On period in order to receive the remaining data from the base station. The wait delays the delivery of the data to the UE, and can also involve additional control plane transactions and/or signaling overhead as a result of the UE transitioning between the DRX On and DRX Off states.

Various approaches exist for determining if and when a UE moves between a DRX On state and a DRX Off state. For example, in LTE release 8-10, an eNB configures the DRX cycle and can send a DRX command control element to the UE to control if and when the UE transitions between the DRX On and DRX Off states. However, there is a chance that the UE may be put into DRX Off state when the UE would have been better served by remaining in DRX On state. This may be because, unknown to the network, downlink data expected by an application in the UE is due to arrive just after the UE has been put into a DRX Off state. In another scenario, the UE may be in a DRX On state and an application on the UE may be aware that no more data is due to be sent to the UE. Therefore the UE may not anticipate receiving any further data in the immediate future and thus does not need to be listening or scanning for signals from the eNB. As such, in many cases the onset of DRX Off state could be better decided with input or information from the UE. In particular, in at least one embodiment, input from the UE to the eNB can comprise or be based on information from one or more applications running on the UE.

However, in LTE Releases 8-10, DRX mechanisms do not provide for input from the UE to the eNB for determining the DRX parameters configuration, or for specific DRX instances, or for selecting the most appropriate DRX state of the UE.

As discussed above, in the current version of LTE, the eNB determines if and when the UE changes DRX states. Exclusive control by the eNB may provide for acceptable performance and behaviour when data traffic between the eNB and the UE is predictable at the eNB. However, in many instances this is not the case. It is often difficult, if not impossible, to predict or anticipate at the eNB when and how much data the UE will want to send or receive. In addition, some UEs will be running a plurality of applications, which can make it even more difficult to predict data traffic between the UE and the eNB. In many cases, the UE is in a better position to determine or at least provide information on an appropriate or desirable time to change between DRX states.

The examples and embodiments provided below describe various methods and systems for controlling the transitioning a User Equipment (UE) or other mobile devices between various states/modes of operation in a wireless network such as, for example, an LTE network. It is to be understood that other implementations in other types of networks are also possible. For example, the same teachings could also be applied to a GSM network, UMTS network, LTE-Advanced Network, among others. The specific examples and implementations described below, although presented for simplicity in relation to LTE networks, are also applicable to these other network environments.

The embodiments below are merely examples and the teachings provided herein could be extended to other technologies. For example, references to an eNB are not meant to be limiting. It is contemplated that a UE can communicate with other types of base stations as well as other components of various types of communications networks. Also, references to DRX states are also not meant to be limiting. The present disclosure can be applied to communications systems and/or protocols that employ other types of power mode states. The term power mode may refer to a state of some UE components. This may include one or more of the DRX states, idle or connected modes of a UE, a signalling configuration (e.g. PUCCH assignment), measurement configuration, reporting configuration, receiver state, transmitter state, battery state, user interaction, and so on.

The term user equipment (UE), as used herein, could be any suitable UE, including, but not limited to a mobile device, mobile station, personal digital assistant, data enabled cellular telephone, pager, laptop, tablet, among others, and could further include a relay such as those in the 3GPP or WiMAX, a mobile subscriber station (MSS), a fixed subscriber station (FSS), among others.

In the following disclosure, the terms DRX On and DRX Off are used to refer to the reception capability (e.g. receiver) of a UE being on, and off, respectively, when the UE is in a DRX state (e.g. Short DRX, Long DRX). Thus, for example, DRX On refers to a state in which the UE is in a DRX state where the receiver of the UE is turned on. On the other hand, DRX Off refers to a state in which the UE is in a DRX state where its receiver is turned off.

As described above, in LTE releases 8-10, DRX mechanisms do not provide for input from the UE to the eNB for determining the DRX configuration parameters, or for specific DRX instances, or for selecting the most appropriate DRX state. In other words, the DRX state of the UE is determined exclusively or almost exclusively by the eNB.

In at least one aspect, the present disclosure provides a self-clocking DRX mechanism that allows a UE to indicate its DRX preference to a network element or base station, for example an eNB. A UE DRX Preference Indication can serve as an attempt by the UE to extend a DRX state, or alternatively to change a DRX state, for example from DRX On to DRX Off, or vice versa. In at least one embodiment, the preference indication can indicate a preference to change or extend the current DRX state of the UE. For example, the UE may be in a DRX On state and want to stay in this state for a period longer than it is scheduled to. As previously mentioned, the UE may be expecting data in the very near future and therefore it may be more efficient and faster if the UE remains in the DRX On state until the data is received. As a further example, the UE may want to move from a DRX On state to a DRX Off state sooner than it otherwise would in order to conserve battery power. For example, the UE may not be expecting any data in the near future. Again, this DRX preference could be indicated to the eNB.

According to one aspect of the present disclosure, a UE DRX preference indication can result in the current power mode state of a UE being extended or changed. For example, a UE DRX preference indication can result in a modification to the timing of a scheduled transition to or from a power mode state of a UE, such as a DRX state in a UE. In at least one embodiment, the modification can be achieved by extending or reducing the amount of time until a state transition in the UE. In some embodiment, the state transition can be a scheduled state transition according to a configured DRX cycle. For example, in the case of a communications system that employs a DRX scheme, a scheduled transition of the UE between DRX On and DRX Off states can be brought forward or postponed in time. The approach of extending or reducing of an amount of time until a state transition is in contrast to alternative approaches that involve changing multiple parameters of a power management scheme, such as for example a DRX parameter set at an eNB. It will be noted that the approach of extending or reducing the time until the next transition can be more flexible to respond to currently observed traffic than proposing configuration parameters that may not be related to traffic characteristics and may have a longer term effect. In other words, extending or reducing the time until the next transition can be more efficient and/or effective in handling unpredictable traffic than modifying configuration parameters of a power mode scheme (e.g. DRX) from time to time

In at least one embodiment, the UE DRX preference indication can comprise or be based on information of one or more applications running on the UE. For example, one or more applications may have information on if and possibly when it is expecting to receive data. The UE or the application may be expecting data for one or more reasons. For example, the UE or application may be expecting to send data because it is waiting for input from an active user. In addition, the UE or application thereon may be expecting to receive data because it has recently transmitted data to a communicating peer and is thus awaiting some form of reply from the network, for example an acknowledgement. Furthermore, a UE or application on the UE may be expecting to receive data from the network at a specific time. For example, the round trip time estimate of the transmission control protocol may indicate to the UE that data from the network is imminently expected, or the expected time the arrival of data is known in UE applications such as periodically updated stock quotes or sports scores. In another example, a UE application may have completed an exchange with a communicating peer and will not be receiving any more data, allowing the UE to immediately transition to a DRX Off state before expiration of the configured DRX timers.

In some circumstances, the default duration of DRX On and/or DRX Off periods may be altered. In other words, the time at which the UE transitions between the DRX On and DRX Off states may be postponed, advanced, or otherwise changed. For example, if the UE is in a DRX On state and is expecting to receive further data on a downlink channel in the very near future, it can sometimes be desirable to slightly delay the scheduled transition of the UE from the DRX On state to the DRX Off state to enable the UE to receive the expected data before the UE enters the DRX Off state. In this sense, the power mode state of the UE is extended. Otherwise, the UE has to wait until the next scheduled DRX On period in order to receive the data from the base station. This delays the delivery of the data to the UE, and can also involve additional control plane transactions and/or signaling overhead as a result of the UE transitioning between the DRX On and DRX Off states. In contrast, the delaying of the scheduled transition from the DRX On state to the DRX Off state can reduce or eliminate the time delays in the data arriving at the UE, and can also reduce or eliminate the transactional and/or signaling overhead involved in the transitioning between DRX On and Off states.

In one aspect of the present disclosure, a UE can indicate to a network element in a communications network the preference of the UE for a power mode state of the UE. For example, the preference can include changing or extending a UE power mode state. In at least one embodiment, the preference of the UE may be a preference to modify a time of an upcoming power mode state transition of the UE. The network element may then make a decision on the power mode state of the UE based at least partly on the indicated preference of the UE. For example, the network element can decide whether to change or extend a power mode state of the UE. This decision may be a decision to extend or change the current power mode state of the UE. The network element may then indicate its power mode state decision back to the UE, possibly in the form of a power mode state indication, and the UE may then respond to the power mode state indication by possibly transitioning to a different power mode state, or extending the current power mode state.

In a further embodiment of the present disclosure, a change in the power mode of the UE involves at least one of turning a reception capability of the UE from an On state to an Off state, and turning a reception capability of the UE from an Off state to an On state. A power mode state transition of the UE may also involve no change in power mode whatsoever, meaning maintaining a reception capability of the UE in its current On or Off state. Thus in this sense, “power mode” can refer to the reception capability of the UE, whereas “power mode state” can refer to a state in a power mode state machine of the UE.

In yet a further embodiment of the present disclosure, the power mode state preference of a UE is based on information within the UE. The information within the UE could, for example, comprise information from or derived from information of one or more applications running on the UE. The UE and/or one or more applications on the UE may have information that could be useful in influencing a transitioning decision on the power mode of the UE.

In at least one embodiment of the present disclosure, a self-clocking DRX approach is provided that does not involve an attempt, for example by a UE, to determine a suitable set of DRX parameters that will apply in the future. Rather, the UE can simply determine its current requirements and use these requirements to determine its preferred power mode state. Current requirements can be determined or based on one or more factors, including, but not limited to, one or more of the applications currently running on the UE, on the current battery state of the UE, on the value of timers active in the UE, on the current state of an interaction with the user, on the current state of transactions with a remote serve, and on the estimated round trip time associated with an expected response from a remote server.

The UE can then generate a DRX preference indication and indicate this preference to a network element, such as an eNB, about whether the UE wants to remain in its current DRX state, or move to another DRX state.

A DRX preference indication, sometimes herein referred to as a UE DRX Preference Indication, can take any suitable form. In at least one embodiment, the indication can be provided in the form of a signal in a physical layer uplink control channel from the UE to the eNB. An example of such a channel is the physical uplink control channel (PUCCH) in an LTE system. The use of a physical control channel to provide DRX preference indications can result in faster response times and/or lower overhead when compared to a higher-level protocol mechanism. Where an indication is provided in a PUCCH signal, the indication requesting a change of state can be provided when the UE is in the DRX Off or the DRX On states.

In addition, in at least one embodiment, the indication can be provided by way of a medium access control (MAC) control element (CE). Further, in at least one embodiment, the indication can be provided by way of a Radio Resource Control (RRC) message, for example in an information element in the RRC message.

It is also possible that in one embodiment, indications can be provided in more than one form. For example some indications can be in the form of PUCCH signals, whereas other indications in the form of MAC CEs. In other words, a particular embodiment need not provide DRX preference indications in a single form only. A single embodiment can provide indications in multiple different forms, including but not limited to PUCCH signals and MAC control elements.

The UE DRX Preference Indication can then be considered by the eNB in determining if and when the UE is to change DRX states. The eNB can accept the DRX preference indication of the UE. In addition, the eNB may reject the DRX preference indication. In at least one embodiment, the eNB can respond to the UE by indicating an acceptance or a rejection of the DRX preference. The response can be provided in any suitable form over any suitable communication means. In at least one embodiment, the response can be in the form of a MAC CE from the eNB to the UE.

In another embodiment, the response can be in the form of Downlink Control Information (DCI) transmitted on the physical downlink control channel (PDCCH) using a structure similar to the single bit control of DCI Format 3A wherein the eNB assigns a bit within the DCI to each UE capable of providing a UE DRX Preference Indication. In one variant of this embodiment, acceptance by the eNB is indicated by a bit value of ‘1’ and rejection is indicated by a bit value of ‘0’.

In other embodiments, the response can be signalled by a DCI encoded with a standardised RNTI, similar to the paging RNTI (P-RNTI), that points to a physical downlink shared channel (PDSCH) region that contains a list of UE identifiers, such as cell radio network temporary identifiers (C-RNTIs). In one variant of this embodiment, the list contains the identifiers of those UEs whose request has been accepted. In another variant of this embodiment, the list contains the identifiers of those UEs whose request has been rejected. In a further variant of this embodiment, each entry in the list is comprised of a UE identifier and an indication of whether the request has been accepted or rejected.

In addition, in at least one embodiment, an eNB can be given a specific amount of time to respond to the DRX preference indication provided by the UE. If the UE does not receive a response before the specific time for responding elapses, the UE can interpret the non-response as an indication that the DRX preference indication was rejected by the eNB. It is also possible that the eNB rejects the preference indication and intentionally does not issue a response. In such a case, since the UE does not receive a response before the time for responding elapses, the UE interprets the non-response as a rejection. The time window for responding for the eNB will sometimes be referred to herein as a UE DRX Preference indication response window.

Where an indication is provided in a PUCCH signal, the indication can be utilized when the UE is in either of the DRX Off and DRX On states. For example, if the UE is in the DRX Off state, after requesting a state change, the UE turns on its receiver and may enter the DRX On state for a period of time (e.g. UE DRX Preference indication response window), while the UE awaits a response from the eNB. If a response from the eNB is not received before the end of UE DRX Preference indication response window, or if the received response indicates that the eNB has rejected the request, the UE may turn off its receiver and may return back to the DRX Off state. Furthermore, in at least one embodiment, the UE is prohibited from indicating any power mode state preference indications during the UE DRX Preference indication response window. In another embodiment, the UE can be limited in the number of additional preference indications that it indicates during the UE DRX Preference indication response window.

The various features and components of the present disclosure are now described with reference to the Figures.

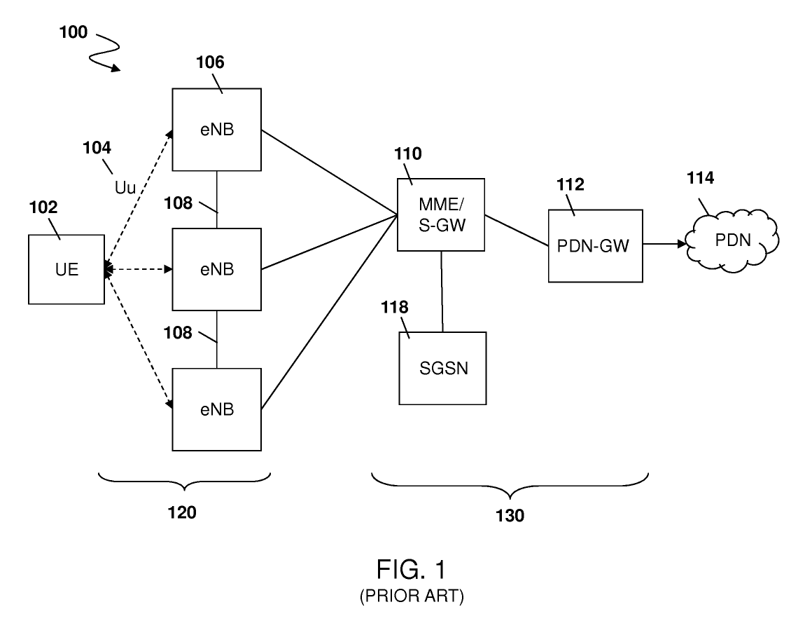

Reference is now made to FIG. 1. FIG. 1 is a block diagram of a communication system 100 that includes a UE 102 which communicates through the wireless communication network.

UE 102 communicates wirelessly with one or more of multiple eNBs 106. Each eNB 106 is responsible for air interface processing and some radio resource management functions. In many regards, eNB 106 provides functionality similar to a Base Transceiver Station in UMTS and GSM/GPRS networks. However, unlike a Node B in UMTS which relies a separate radio network control (RNC) for control functionality, an eNB typically comprises its own embedded control functionality.

The wireless link shown in communication system 100 of FIG. 1 represents one or more different channels, typically different radio frequency (RF) channels, and associated protocols used between the wireless network and UE 102. A Uu air interface 104 can be used between UE 102 and eNB 106.

An RF channel is a limited resource that must be conserved, typically due to limits in overall bandwidth and a limited battery power of UE 102. Those skilled in art will appreciate that a wireless network in actual practice may include hundreds of cells depending upon desired overall expanse of network coverage. All pertinent components may be connected by multiple switches and routers (not shown), controlled by multiple network controllers.

Each eNB 106 communicates with a mobility management entity (MME) 110, which is a control-node for the LTE access-network. System 100 can also comprise a serving gateway (S-GW), which for simplicity is shown as being combined with MME 110 in FIG. 1. The S-GW routes and forwards user data packets and also serves as a mobility anchor for the user plane during inter-eNB handovers. In addition, the S-GW may also serve as an anchor for mobility between LTE and other 3GPP technologies. Furthermore, MME/S-GW 110 can be connected to a Serving General Packet Radio Service (GPRS) Support Node (SGSN) 118. The SGSN 118 can in turn communicate with a Gateway GPRS Support Node (GGSN), which is not shown. The GGSN can serve as the interface between the UMTS/GPRS network and other networks such as the Internet or private networks.

Furthermore, eNBs 106 can communicate with one another over an X2 interface 108 using the X2-AP protocol.

The MME/S-GW 110 can be connected to a public data network (PDN) 114 via a PDN gateway (PDN-GW) 112. PDN-GW 112 provides connectivity from the UE to external packet data networks by being the point of exit and entry of traffic for a UE 102. A UE may be simultaneous connected with multiple PDN-GWs for accessing multiple PDNs.

In system 100, evolved universal terrestrial radio access network (E-UTRAN) 120 comprises the eNBs 106 and the Uu air interface 104. The MME/S-GW 110 and PDN-GW 112 comprise the evolved packet core (EPC) 130.

Those skilled in art will appreciate that wireless network may be connected to other systems, possibly including other networks, not explicitly shown in FIG. 1. A network will normally be transmitting at very least some sort of paging and system information on an ongoing basis, even if there is no actual packet data exchanged. Although the network consists of many parts, these parts all work together to result in certain behaviours at the wireless link.

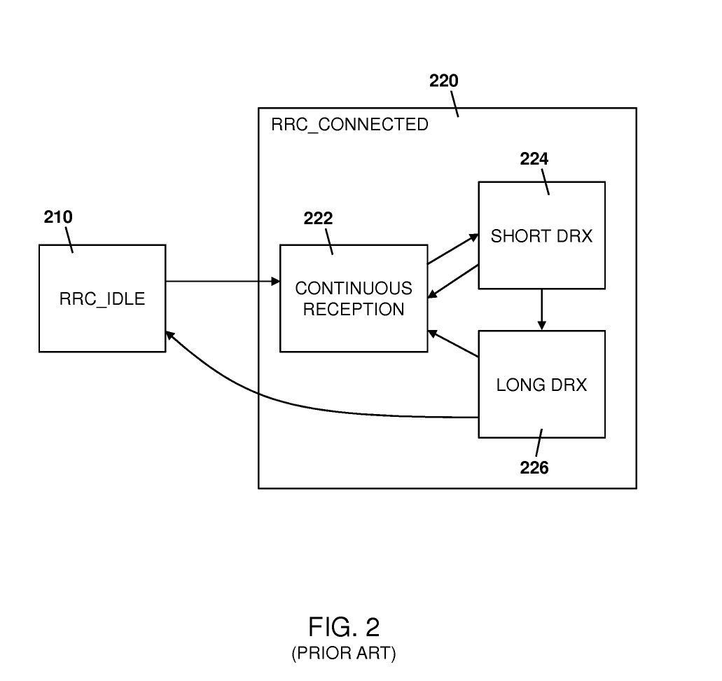

Reference is now made to FIG. 2. FIG. 2 is a block diagram showing the various modes and states for the radio resource control portion of a protocol stack in an LTE network. In particular, UE 102 can be either in an RRC idle mode 210 (RRC_IDLE) or an RRC connected mode 220 (RRC_CONNECTED).

In idle mode 210, the UE must request an RRC connection to receive an allocation of radio resources whenever data needs to be exchanged between the UE and the network.

Once the radio connection has been established, the E-UTRAN chooses a state for the RRC connection to be in. Specifically, the RRC connected mode 220 includes three separate states. These are Continuous Reception state 222, Short DRX state 224, and Long DRX state 226.

Within the RRC connected mode 220, the RRC state can be changed at the discretion of the E-UTRAN. Specifically, if data inactivity is detected for a specific amount of time, the E-UTRAN may move the RRC state from Continuous Reception state 222 to the Short DRX state 224 or the Long DRX state 226. Similarly, if data destined for the UE is available in the E-UTRAN then the RRC state of the UE can be changed from Short DRX state 224 or Long DRX state 226 to Continuous Reception state 222.

In Short DRX state 224 and Long DRX state 226, the UE uses a configured discontinuous reception cycle (DRX) to periodically monitor broadcast messages and pages on a physical downlink control channel (PDCCH). The UE may also use a configured DRX cycle while in idle state 210 to periodically monitor for messages. The UE monitors the PDCCH at predefined time intervals according to a DRX cycle.

As will be appreciated by those skilled in the art, from a battery life perspective, the idle mode can provide the lowest battery usage compared with the states above. Specifically, because the UE is required to monitor the PDCCH channel only at intervals, the radio does not need to continuously be on, but will instead wake up periodically. A trade-off for this is the latency to receive data at the UE. However, if this latency is not too great, the advantages of being in the idle mode and saving battery power may outweigh the disadvantages of the connection latency.

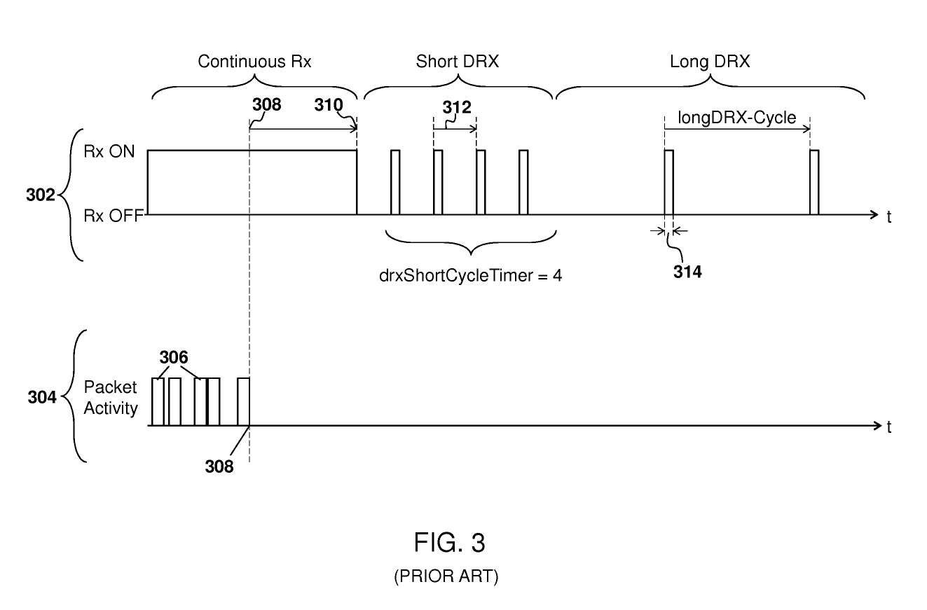

Reference is now made to FIG. 3, which shows an example timing diagram of a UE showing the receiver status 302 (e.g. on or off) of the UE as well as packet activity 304 to and from the UE. The left-most portion of the diagram shows the UE in the Continuous Receive (Rx) state as downlink and/or uplink assignment grants for new data packets are issued to the UE. Each time a new downlink or uplink assignment is made to the UE, an inactivity timer is typically started. If and when the time of the inactivity timer elapses, the UE can be moved into a power mode state such as Short DRX or Long DRX states. For example, in FIG. 3, drx-InactivityTimer is started at time 308 upon the last downlink or uplink assignment to the UE. When the time of drx-InactivityTimer elapses at time 310, the UE can move from the Continuous Rx state to the Short DRX state, for example. Since the radio of the UE has not been used to receive data for the duration of the drx-InactivityTimer, the UE moves into a lower power mode. In the Short DRX state, the UE will toggle its receiver off and on at a predefined frequency. Each on/off cycle is referred to as a DRX cycle and the length of the cycle can be referred to as shortDRX-Cycle. The shortDRX-Cycle 312 is indicated in FIG. 3. Within each cycle, the receiver can be turned on for ‘x’ sub-frames, and then turned off for ‘y’ sub-frames. The ‘on’ time of the receiver during a DRX cycle can be referred to as on DurationTimer 314.

As indicated in FIG. 3, a period during which the UE is in a DRX state while the receiver is turned on is referred to as a “DRX On” phase. A period during which the UE is in a DRX state while the receiver is turned off is referred to as a “DRX Off” phase.

If no user data is transmitted to the UE for a predetermined amount of time in the Short DRX state, the UE may move into a Long DRX state in an attempt to further conserve battery power during the period of inactivity. In FIG. 3, the predetermined amount of time is shown in the form of a drxShortCycleTimer, which has been given an example value of 4 short DRX cycles. Thus when the inactivity of the UE continues for the duration of 4 Short DRX cycles, the UE is moved from the Short DRX state into the Long DRX state. It will be observed that in the example of FIG. 3, the receiver of the UE remains inactive from time point 308 as the UE moves from Continuous Rx state, to the Short DRX state, and then to the Long DRX state. Similarly to the Short DRX cycle, the Long DRX cycle can have a cycle made up of at least one DRX On phase and one DRX Off phase. An example Long DRX cycle is indicated in FIG. 3 as longDRX-Cycle.

As described above, one embodiment of the present disclosure provides a self-clocking DRX mechanism that allows a UE to indicate its DRX preference to a network or base station, for example an eNB. A UE DRX Preference Indication can serve as an attempt by the UE to extend its current DRX state, or alternatively to trigger a change in its current DRX state, for example from DRX On to DRX Off, or vice versa. This altering of scheduled DRX state changes can result in reduced latency and conservation of battery power. It can also provide for increased efficiencies, for example by reducing the number of transitions between the various UE states, including the DRX states and the Continuous Reception state. In many instances, the number of these transitions may be minimized as each transition can require significant signaling overhead and associated consumption of battery power.

A UE preference indication from a UE to the network (e.g. base station) can cause a modification to the timing of a transition to or from a power mode state of a UE, such as a DRX state in a UE. For example, in at least one embodiment of the present disclosure, the modification can be achieved by extending or reducing the amount of time until a state transition in the UE. For example, in the case of a communications system that employs a DRX scheme, a scheduled transition of the UE between DRX On and DRX Off states can be brought forward or postponed in time. In other embodiments, a modification of a time of a transition can involve modifying the time of a scheduled power mode state transition of the UE.

A transition of the UE may be modified in certain situations as it might possibly reduce latencies and/or overhead incurred as a result of the transitions. For example, in an LTE Release 8-10 system, if a UE is in a DRX On state and is expecting to receive further data on a downlink channel in the very near future, the UE may nonetheless be transitioned from the DRX On state to the DRX Off state due to a normal scheduled transition. The UE therefore must wait until the next scheduled DRX On period to receive the remaining data from the base station. This wait delays the delivery of the data to the UE and can also involve additional control plane transactions and/or signaling overhead as a result of the UE transitioning between the DRX On and DRX Off states. In at least one embodiment of the present disclosure, the timing of a transition can be modified to reduce latency in the communications system and also to reduce the overall number of DRX state transitions in a UE. For example, in the preceding example, a normal scheduled transition from the DRX On state to the DRX Off state can be postponed until after the UE has received the remaining data from the base station. Thus the UE receives the remaining data without having to move into the DRX Off state and then back into the DRX On state.

The preceding scenario provides an example according to the present disclosure of a postponement of a transition in a UE from a DRX On state to a DRX Off state. However, the present disclosure further provides that the timing of other transitions in a UE can also be modified. For example, a transition in a UE from a DRX Off state to a DRX On state can be postponed. This may be utilized, for instance if there is no data expected to be received by the UE. In addition, scheduled state transitions can also be brought forward in time. For example, a transition in a UE from a DRX Off state to a DRX On state can be brought forward so the UE waits less time to receive data. Similarly, a transition from a DRX On state to a DRX Off state can be brought forward in time, for example, if no data is expected for transmission to the UE. The latter situation is sometimes generally referred to as fast dormancy.

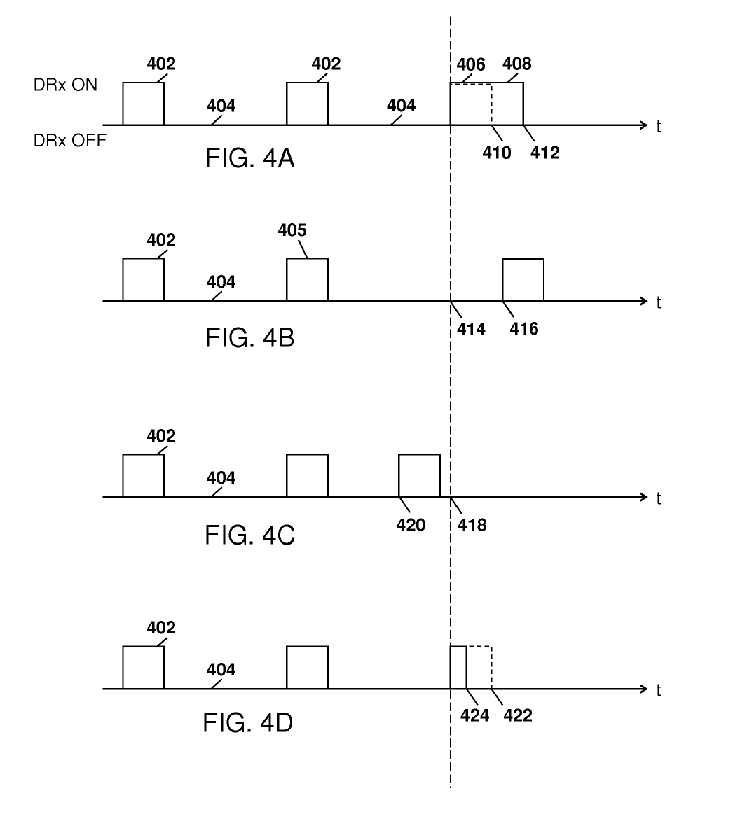

The above four scenarios are depicted in the example timing diagrams shown in FIG. 4A to FIG. 4D.

FIG. 4A shows a postponement of a transition from the DRX On state to the DRX Off state. In other words, a power mode state (here DRX On) of the UE is extended. In general, the receiver of the UE is turned on during DRX On states 402, and is turned off during DRX Off states 404. However, in this example, the scheduled transition from DRX On to DRX Off at DRX On cycle 406 is postponed or delayed from time 410 to time 412. Thus this particular continuous DRX On period is made of up DRX On portions 406 and 408.

FIG. 4B illustrates the second scenario wherein a transition in a UE from a DRX Off state to a DRX On state is postponed. In other words, the DRX Off state of the UE is extended. In particular, the transition to DRX On is delayed from time 414 until time 416. The DRX On state may be postponed, for example, if there is no data waiting and/or expected to be transmitted to the UE. The UE could indicate such a preference to the eNB, for example, during DRX On phase 405 or during the DRX Off period prior to time 514. Those experienced in the art will recognize that while UE reception is not expected during the DRX Off period, UE transmission can in fact be allowed, for example, by using pre-allocated physical uplink control channel resources Furthermore, in at least one embodiment, the next scheduled DRX On phase following the postponed DRX On phase can occur as usual.

FIG. 4C shows the third scenario in which a transition from the DRX Off state to the DRX On state is brought forward in time. Here, the transition from DRX Off to DRX On is moved forward from time 418 to time 420. In one embodiment, if the DRX On state is brought forward, the UE may then not perform a DRX On at time 418. In other embodiments, if the DRX Off occurs before time 418 the UE may continue its normal DRX schedule and proceed to DRX On at time 418.

FIG. 4D illustrates the fourth scenario wherein a transition from the DRX On state to the DRX Off state is changed to occur earlier in time. In this scenario, the transition from DRX On to DRX Off is advanced from time 422 to time 424. This transition can be the result of an advancement in time of a scheduled state change, or the state can simply be changed at the desired time, here time 424, without necessarily modifying the time of a scheduled state change.

As previously described, a UE can signal a UE DRX preference indication to the communications network, for example to a base station, which can result in a modification to the timing of a scheduled transition to or from a power mode state of a UE. In at least one embodiment, input from the UE can comprise or be based on information from one or more applications running on the UE. For example, the UE or an application may be expecting to receive data in the near future. The UE or the application may be expecting data, for example, because it is awaiting user data (e.g. a part of a file), or possibly because it has recently transmitted user data to the network and is therefore awaiting an acknowledgement. This information can be used to generate or otherwise provide a UE DRX preference indication to the communications network regarding the DRX state of the UE. For example, the preference indication could indicate that it is desirable for the UE to either remain in a DRX On state, or if the UE is in the DRX Off state that it should move into the DRX On state earlier than scheduled.

Therefore the preference indication can be based on information in the UE, including information on or from one or more applications on the UE. In addition, the preference indication can be based on other factors, including but not limited to the current state of battery power in the UE or on the current state of an interaction with the user. Again, this is only an example and other possibilities for modifying the timing of scheduled transitions of the UE between DRX On and DRX Off states are possible. For example, some other possibilities for modifying the timing of scheduled transitions are described above with reference to FIGS. 4A to 4D.

In at least one embodiment, the communications network (e.g. base station) can configure the maximum amount of time it will take the network to respond to the DRX preference indication provided by the UE. The network can accept the DRX preference indication of the UE and subsequently implement the preference, for example postponing or advancing a transition between DRX states. Alternatively, the network may reject the DRX preference indication whereby the preference indication of the UE can be ignored. In at least one embodiment, the network can respond to the UE by indicating an acceptance or a rejection of the DRX preference indication.

As previously discussed, the network can configure the maximum time period or window in which to respond to the UE indication. If the UE does not receive a response before the specific time for responding elapses (e.g. UE DRX Preference indication response window), the UE may interpret the non-response as an indication that the DRX preference indication was rejected by the network. While the above situation may occur due to a communication error, it is also possible that the network rejects the preference indication but does not issue a response to the UE. Rather, the network can merely not respond. In such a case, the UE interprets the non-response of the network as a rejection of the preference indication.

In addition, in at least one embodiment, the UE is considered to be in a power mode that allows it to receive eNB indication responses before a scheduled or requested state change. If the UE receives a response that the preference indication was rejected, or the UE receives no response before an indication response window expires, the UE can return to its previous power mode. For example, if the UE is in the DRX Off state, after requesting a state change, the UE changes its power mode by turning on its receiver and enters the DRX On state for a period of time (e.g. UE DRX Preference indication response window), while the UE awaits a response from the network (e.g. base station or eNB). If the UE does not receive a response from the network the UE DRX Preference indication response window elapses, or if the received response indicates that the request has been rejected, the UE can return to DRX Off state and, optionally, return to its previous power mode by turning off its receiver.

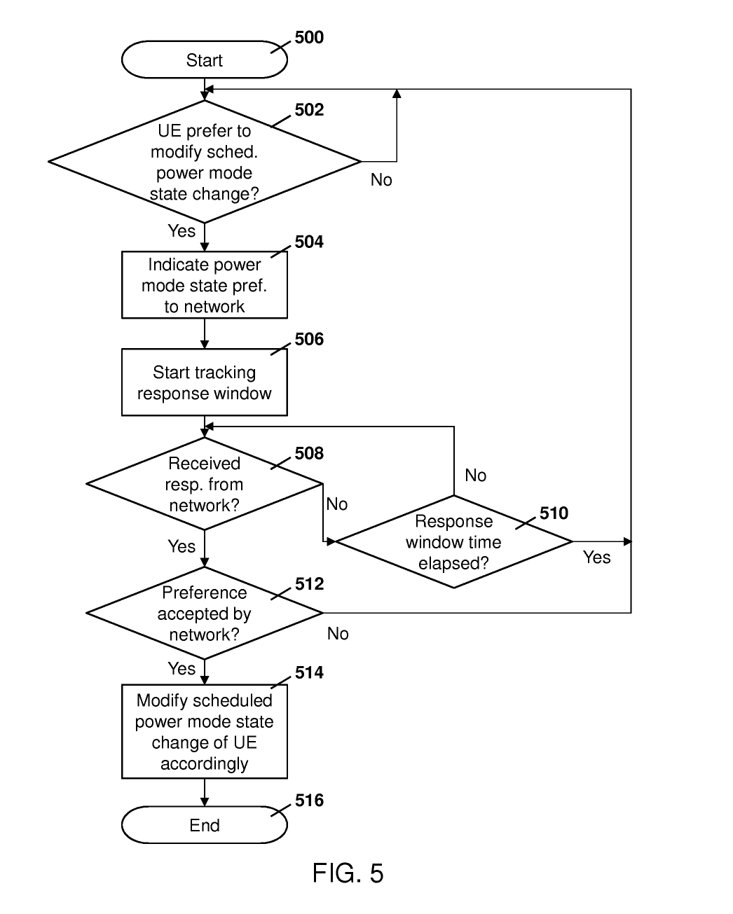

Reference is now made to FIG. 5, which is a flow diagram of a process showing at least some of the steps at a UE when the UE signals a DRX preference indication to an eNB in at least one embodiment of the present disclosure. The process begins at block 500 and proceeds to block 502 at which the UE determines if it wants to provide a UE DRX preference indication to the network or eNB to initiate a modification to the timing of a DRX state transition. If the UE determines that it does not want to provide a DRX preference indication, the process loops back to block 502 and continues to check whether the UE wants to alter the scheduled DRX transition. If, on the other hand, the UE wants to provide an indication to the network, the process proceeds to block 504, at which the UE provides the DRX preference indication to the network or eNB.

From block 504 the process may proceed to block 506 at which the UE starts to track a UE DRX Preference indication response window, which was described above. The response window can be used by the UE to enable it to take some type of action if it does not receive a response to its preference indication from the network within a specified amount of time.

The process then proceeds from block 506 to block 508, where it is determined if a response has been received from the network or eNB. If a response has been received or otherwise indicated by the network, the process proceeds to block 512. However, if a response has not been received from the network, the process proceeds to block 510 where a check is made to determine if the indication response window has elapsed. If the window has elapsed then the UE can proceed back to block 502. If the window has not expired, then the process returns to block 508 to again check for a response from the network.

At block 512, the UE determines if its DRX preference indication has been accepted or rejected by the network. If the DRX preference indication has been rejected, the process proceeds to block 502. On the other hand, if the indication has been accepted by the network, the process proceeds to block 514 where the timing of one or more DRX state transitions of the UE can be modified in accordance with the particular DRX preference that was indicated by the UE.

The process then proceeds to end block 516.

The flow diagram shown in FIG. 5 is only meant as an example and is not intended to be limiting.

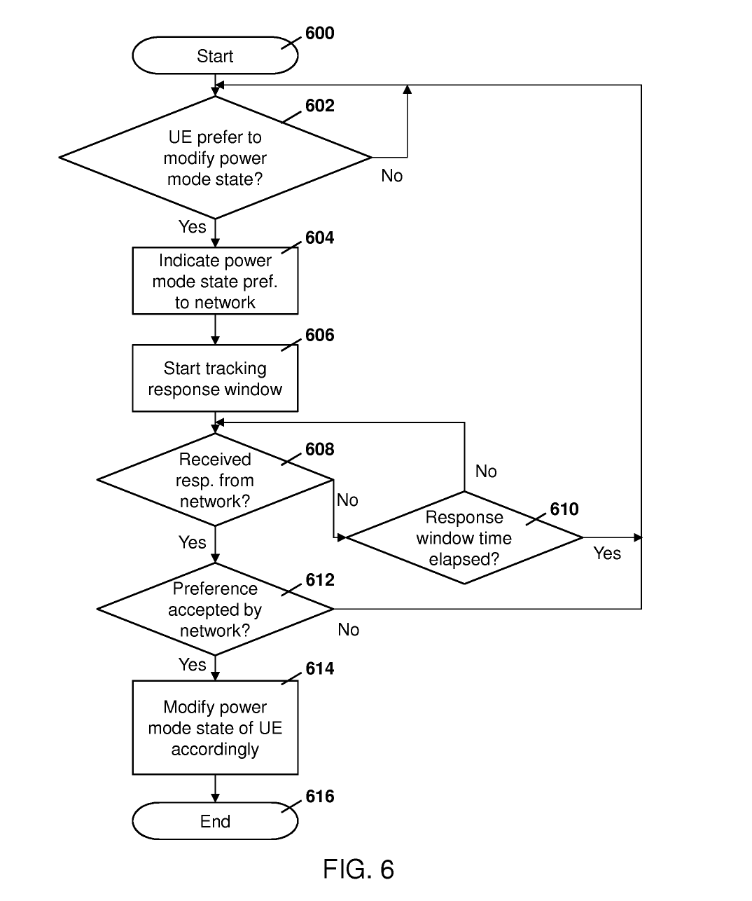

Reference is now made to FIG. 6, which is a flow diagram showing a process that is similar to the process of FIG. 5. However, in the embodiment shown in FIG. 6, the network or eNB does not configure the UE with timer values for scheduled DRX state transitions. Instead, all DRX state transitions are driven explicitly by the UE. The UE will remain in a particular DRX state until it signals its preference to change state and that preference is accepted by the network. The process begins at block 600 and proceeds to block 602 at which the UE determines if it wants to provide a UE DRX preference indication to the network or eNB to initiate a change in the DRX state of the UE. If the UE determines that it does not want to provide a DRX preference indication, the process loops back to block 602 and continues to check whether the UE wants to alter the current DRX state of the UE. If, on the other hand, the UE wants to provide an indication to the network, the process proceeds to block 604, at which the UE provides the DRX preference indication.

From block 604 the process may proceed to block 606 at which it starts to track a UE DRX Preference indication response window, which was described above. The response window can be used by the UE to enable it to take some type of action if it does not receive a response to its preference indication from the network within a specified amount of time.

The process then proceeds from block 606 to block 608, where it is determined if a response has been received from the network or eNB. If a response has been received or otherwise indicated by the network, the process proceeds to block 612. However, if a response has not been received from the network, the process proceeds to block 610 where a check is made to determine if the indication response window has elapsed. If the window has elapsed then the process can proceed back to block 602. If the window has not elapsed, then the process returns to block 608 to again check for a response from the network.

At block 612, the UE determines if its DRX preference indication has been accepted or rejected by the network. If the DRX preference indication has been rejected, the process proceeds to block 602. On the other hand, if the indication has been accepted by the network, the process proceeds to block 614 where the DRX state of the UE can be modified in accordance with the particular DRX preference that was indicated by the UE.

The process then proceeds to end block 616.

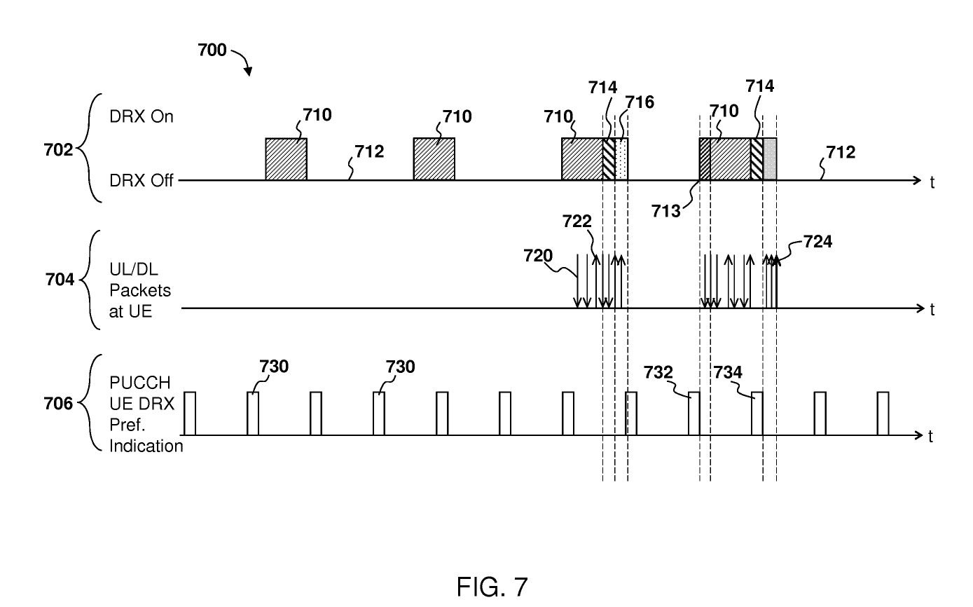

Reference is now made to FIG. 7, which shows an example timing diagram indicating the DRX state 702 (e.g. On or Off) of a UE, the packet activity 704 at the UE, and a DRX preference indication 706 of the UE. Region 702 of the diagram shows periodically scheduled DRX On periods 710 and DRX Off periods 712. Also shown in region 702 are DRX-HARQ DRX On extension periods 714 when a DRX-HARQ (hybrid automatic repeat request) timer is on. The DRX-HARQ DRX On extension periods allow the HARQ retransmissions to complete before the radio of the UE is turned off and the UE enters a DRX Off period 712. As is appreciated by those skilled in the art, HARQ is a hybrid error controlling and error correcting method for data transmission. In addition, an inactivity timer DRX On extension period 716 is also indicated in region 702 of the flow diagram. An inactivity timer can be started once all HARQ retransmissions are complete. The DRX On duration can be extended (e.g. extension period 716) when the DRX inactivity timer is on to allow any remaining traffic to be served before the UE enters a DRX Off period 712.

Region 704 of the flow diagram shows the corresponding packet traffic at the UE. The traffic is indicated by way of arrows 722 pointing up for uplink packets and arrows 720 pointing down for downlink packets. In the present example, during the third DRX On period shown (third from the left), the UE receives some TCP data, replies with an ACK and then sends some radio access network (RAN) control messages. The UE then receives subsequent TCP data for which it sends an ACK. The UE estimates the round trip time for the next set of TCP data to occur before the start of the next DRX On period, which is the right-most DRX On period 710 in region 702.

Third region 706 of FIG. 7 shows the DRX preference indication of the UE transmitted in a periodic PUCCH allocation. The UE DRX preference indication can allow for the modification of the timing of scheduled transitions between the DRX On and DRX Off states. In at least one embodiment, the transitions can be influenced by the current UE state without changing the configured DRX parameters to accommodate an expectation of downlink traffic. In this particular example, the UE uses a physical uplink control channel (PUCCH) in an LTE system to provide its indication to the network. However, the use of a PUCCH by the UE is only an example and is not intended to be limiting.

Referring to region 706 of FIG. 7, the UE can use one or more PUCCH allocations 730 to provide UE DRX preference indications to indicate that the UE prefers to move from the DRX Off state to the DRX On state sooner than scheduled. Alternatively, the UE could use another type of intervening uplink grant opportunity other than the PUCCH to provide its indication. In the example shown, the UE uses PUCCH allocation 732 to indicate that it prefers to move into the DRX On state sooner than scheduled. The network (e.g. eNB) accepts the DRX preference, the UE moves into the DRX On at time 713 (see region 702) and the UE is able to receive the TCP data sooner, thereby avoiding prolonged buffering of the data at the eNB. The next PUCCH allocation for UE DRX preference indication 734, or an intervening uplink grant, is also used by the UE to allow it to receive the final set of TCP data. After sending its TCP ACK to the received TCP data, the UE requests an earlier transition back to DRX Off by sending a UE DRX Preference Indication MAC CE indicated by an upward arrow 724 (shown in region 704) along with its TCP ACK to the eNB. The eNB accepts and the UE moves back to the DRX Off state earlier than scheduled (not shown).

Various options exist according to the present disclosure for indicating a DRX preference to a network or base station.

In at least one embodiment, a UE DRX preference indication can be in the form of a single bit, which can be communicated or otherwise signalled from the UE to an eNB. For example, the setting of the bit (i.e. to ‘1’) can indicate to the eNB that the UE prefers to be in a DRX On state. The setting of the bit to ‘0’ can indicate that the UE prefers to be in a DRX Off state. In at least one other embodiment, the meanings of the values of the bit can be reversed, meaning ‘1’ can indicate a UE preference for the DRX Off state and a ‘0’ a UE preference for the DRX On state.

Reference is now made to Table 1, which is a table representing one embodiment of this method of indicating the UE preference to the eNB.

TABLE 1
Single bit input for UE DRX preference

| | UE current state = | UE current state = |
|---|---|---|
| | DRX On | DRX Off |
| UE DRX Preference | UE would like to | No action required |
| indication = DRX Off | change state to DRX | by network; network |
| (bit = ‘0’) | Off; if acceptable, | may respond with |
| | network may | positive ACK |
| | respond with positive | |
| | ACK | |
| UE DRX Preference | No action required by | UE would like to |
| indication = DRX On | network; network | change state to |
| (bit = ‘1’) | may respond with | DRX On; if |
| | positive ACK | acceptable, network |
| | | may respond with |
| | | positive ACK |

The columns of Table 1 represent the current DRX state (On or Off) of a UE, whereas the rows represent the preference of the UE. Again, the DRX preference indication of the UE can be only a preference, meaning that an eNB does not necessarily have to accept the preference. For example, when the UE is in the DRX On state and prefers to enter the DRX Off state, the UE indicates this preference to the eNB by clearing the single indication bit (bit=‘0’). Upon learning of the preference of the UE, the eNB (or network) may accept the preference. The eNB may also indicate a response to the UE, for example a positive acknowledgement (ACK) if the eNB accepts the preference. Alternatively, the eNB may indicate a negative acknowledgement (NACK) to the UE if the eNB rejects the preference indication.

In at least one embodiment, a signal for the UE DRX preference indication is sent to the eNB using the PUCCH. Furthermore, in at least one embodiment a periodic PUCCH allocation for a UE DRX preference can be provided to the UE via RRC signalling. In particular, DRX preference indications can be signalled by way of PUCCH Format 1 messages. For example, a PUCCH format type ‘1’ can be transmitted by the UE for indicating its DRX preference. In such a case, the mere presence of a signal (e.g. a type ‘1’ message) from the UE indicates that the UE prefers to change its current DRX state, for example from DRX On to DRX Off, or vice versa. In another embodiment, a PUCCH format type ‘1a’ can be transmitted by the UE to indicate its DRX preference. In this case, a binary ‘1’ can indicate that the UE prefers to be in the DRX On state, whereas a binary ‘0’ can indicate that the UE prefers to be in the DRX Off state.

Reference is now made to Tables 2 and 3 below, which each provide a table representing another type of option for indicating the preference of a UE to an eNB. Here, a periodic PUCCH allocation can be provided for signalling a UE DRX preference indication, a scheduling request (SR), or both to an eNB. The UE indication for a scheduling request and the UE DRX preference indication can be combined using PUCCH format ‘1b’ which, using quadrature phase shift keying (QPSK), provides two bits of information. When there are no outstanding downlink transmissions waiting for HARQ ACK/NAK, PUCCH format ‘1b’ signals can be interpreted by the eNB as indicating a UE DRX Preference.

TABLE 2
SR and UE DRX preference

| | UE preference = | UE preference = |
|---|---|---|
| | DRX Off | DRX On |
| No Scheduling Request | 00 | 01 |
| (SR) | | |
| Scheduling Request | 10 | 11 |
| (SR) | | |

In the embodiment of Table 2, a binary ‘00’ can indicate no SR and a UE preference for the DRX Off state. A binary ‘01’ can indicate no SR and a UE preference for the DRX On state. A binary ‘10’ can indicate a SR and a UE preference for the DRX Off state after the uplink transmission has completed (e.g. indicated by a buffer status report (BSR) of 0). A binary ‘11’ can indicate a SR and a UE preference for the continuation of the DRX On state after the uplink transmission for which the SR was sent has completed.

TABLE 3
SR and UE DRX preference

| | UE preference = DRX | UE preference = |
|---|---|---|
| | Off | DRX On |
| No Scheduling Request | 00 | 01 |
| (SR) | | |
| Scheduling Request (SR) | — | 11 |

The signalling of a SR causes a subsequent transition to an active state in some LTE standards. Accordingly, in at least one embodiment, as shown in Table 3, a binary ‘00’ indicates no SR and a UE preference for DRX Off state. A binary ‘01’ indicates no SR and a UE preference for DRX On state. A binary ‘11’ indicates a SR (and a subsequent transition to the DRX On state). A binary ‘10’ is undefined and reserved for future use.

In another embodiment, which is not shown, a binary ‘10’ can be defined as a preference for the DRX Off state and for a release of PUCCH resources, suggesting that the UE is not expecting a near-term need for uplink or downlink transmissions.

In another embodiment, which also is not shown, the UE indication for scheduling request can be combined with the DRX preference indication using PUCCH format ‘1a’ which, using BPSK, can provide a more robust coding but only one bit of information. In this case, a binary ‘0’ can indicate a change to the other DRX state while a binary ‘1’ can indicate a SR (and a subsequent transition to the DRX On state). No transmission by the UE can indicate no change in the DRX state and no SR.

In addition to using PUCCH Format 1 control information, various other embodiments can employ PUCCH Format 2 control information. For example, a periodic PUCCH allocation can be provided for signalling a UE DRX preference indication and a channel quality indicator (CQI) to an eNB. In at least one embodiment, the UE DRX preference indication and CQI are combined using a PUCCH format ‘2a’ message, which, using BPSK for the preference indication, provides one bit of information. When there are no outstanding downlink transmissions waiting for HARQ ACK/NACK, PUCCH format ‘2a’ signals can be interpreted by the eNB as indicating a UE DRX Preference. For example, a binary ‘0’ can indicate a preference for the DRX Off state and a binary ‘1’ can indicate a preference for the DRX On state. However, it is to be appreciated that in another embodiment the meaning of the bit values can be reversed.

In another embodiment, the UE DRX preference indication and CQI can be combined into a PUCCH format ‘2b’ message which, using QPSK for the preference indication, provides two bits of information. In this case, a binary ‘00’ can indicate a preference for the DRX Off state and an immediate start of the short DRX cycle (Short DRX). A binary ‘01’ can indicate a preference for the DRX Off state and an immediate start of the long DRX cycle (Long DRX). A binary ‘10’ can indicate a preference for the DRX Off state and for a release of PUCCH resources, suggesting that the UE is not expecting a near-term need for uplink or downlink traffic transmissions. A binary ‘11’ can indicate a preference for the DRX On state.

In yet another embodiment, a binary ‘00’ indicates a preference for the DRX Off state. A binary ‘01’ indicates a preference for the DRX Off state and for a release of PUCCH resources excluding PUCCH SR, suggesting that the UE is not expecting a near-term need for downlink traffic transmissions but recognizes the possibility of needing uplink resources. A binary ‘10’ indicates a preference for the DRX Off state and for a release of all PUCCH resources, suggesting that the UE is not expecting a near-term need for uplink or downlink traffic transmissions. A binary ‘11’ indicates a preference for DRX On state.

In addition to using PUCCH Format 1 and Format 2 control information to convey a UE DRX preference indication, it is also possible to indicate the DRX preference by way of a MAC control element (CE) sent from the UE to the eNB.

In some embodiments, the UE may be able to predict the time before a DRX state transition is required and can signal to the eNB the duration by which it wants to postpone or advance the DRX state change. In at least one of these embodiments, the UE indication of this duration may be conveyed to the eNB in a MAC CE sent from the UE to the eNB. For descriptive purposes, the MAC CE will herein be referred to as UE DRX Change indication CE, which can be sent from the UE to the eNB to indicate a request to change the start of the next DRX opportunity. In some embodiments this indication can also be sent in a control channel such as the PUCCH.

In at least one embodiment, a single bit of information can be conveyed to the eNB as a DRX preference. A binary ‘0’ can be a preference indication to start the DRX Off state earlier than scheduled. A binary ‘1’ can a preference indication of the UE to start the DRX Off later than scheduled. The time interval by which the state change is postponed or advanced can be signalled by the eNB either in a system information block (SIB) message, in an RRC message, or by any other suitable means.

Furthermore, in at least another embodiment, several bits can be used by the UE to indicate to the eNB the duration of the requested extension in DRX state. The control element of the MAC message can provide a binary indication, herein referred to as DRX Change Type, using one bit to indicate a preference to either effect the DRX state change earlier (advance) or later (postpone) than scheduled.

The MAC control element can also provide an indication of the time by which the start of the next DRX state change is requested to be altered. This indication can be referred to as DRX Change Duration. If the DRX Change Type is to postpone the DRX state change, then the next DRX state change is expected to start DRX Change Duration units of time (e.g. subframes) after the scheduled start of the next DRX state change. On the other hand, if the DRX Change Type is to advance the DRX state change, then the next DRX state change is expected to start DRX Change Duration units of time (e.g. subframes) earlier than the scheduled start of the next DRX state change.

In one embodiment the UE DRX preference indication as a MAC CE or a PUCCH signal may be used in conjunction with the UE DRX Change Duration indication.

As described above, a network element (e.g. base station, eNB, etc.) may indicate to the UE that its DRX preference has been accepted or rejected. For example, an eNB can transmit a response in the form of or within a MAC CE to the UE.

In at least one embodiment, reception of the existing MAC DRX Command CE (specified in 3GGP TS 36.321 v.9.3.0) can be interpreted by the UE as acceptance of the UE DRX Preference. If the UE does not receive confirmation through a MAC DRX Command CE, the UE can stay in its current state and, if necessary, retransmit its UE DRX Preference at the next PUCCH or uplink grant opportunity.

In at least another embodiment, a new MAC DRX On Command CE or a DRX Off Command CE is signalled from the eNB to indicate the choice of DRX state made by the eNB. This choice is binding on the UE. If the DRX command matches the UE DRX Preference, this is an acceptance of the preference of the UE. If the DRX command does not match, this is a rejection of the DRX preference of the UE. In some embodiments, the DRX On and DRX Off Commands are each allocated a MAC CE logical channel ID (LCID) with a fixed size body of zero bits. In some other embodiments DRX On and DRX Off commands can be indicated by a bit in a DRX Command CE with a fixed body size of 1 bit.

Furthermore, in one or more embodiments, the UE can assume that the UE DRX Preference indication used to change the DRX state of the UE has not been accepted if either a DRX On MAC CE or a DRX Off MAC CE is not sent by the eNB within a specified interval of time. As previously discussed, this time interval can be referred to as “UE DRX Preference indication response window”. In at least one embodiment, the UE DRX Preference indication response window can be configured by the eNB.

Various approaches according to the present disclosure for indicating a preferred DRX configuration from the UE to a network are now described.

Within the 3GPP Radio Access Network 2 (RAN2) enhanced Diverse Data Applications (eDDA), in one embodiment a UE may be configured to provide one bit of information to assist the eNB is determining DRX settings (see e.g. 3GPP TR 36.822, “LTE RAN Enhancements for Diverse Data Applications”, V 0.4.1, May 2012). This input to the eNB from a UE may be in the form of a UE DRX preference indication described above, or in some other format conveying a power optimized configuration.

In some embodiments of the present disclosure, one of the various signalling mechanisms described above may be used to convey this UE DRX configuration preference, herein referred to as “UE DRX Configuration Preference”, for a DRX power mode power saving configuration that is primarily optimised for power saving (herein referred to as “Configuration A” for descriptive purposes) or a DRX power mode configuration that is not optimized for power optimization (herein referred to as “Configuration B” for descriptive purposes). For example, a MAC DRX Command CE responsive to a UE preference indication may be sent by the eNB to either accept or reject the UE preference. In at least one embodiment, a MAC DRX Command CE can be implemented in the same or a similar manner as the MAC DRX On/Off Command CEs described above. Furthermore, if the UE does not receive any MAC DRX Command CE from the eNB, the UE can assume that if the UE had requested a change in DRX state, the request has been rejected.

As previously mentioned, a UE DRX Configuration Preference from the UE to the eNB may be in the same or a similar form of a UE DRX preference indication described above. These are now briefly described.

In at least one embodiment, a PUCCH format type ‘1’ can be transmitted by the UE for indicating UE DRX Configuration Preference. The presence of a signal from the UE at the eNB can indicate that the UE prefers the current DRX configuration to change.

In at least another embodiment, a PUCCH format type ‘1a’ is transmitted by the UE to the eNB for indicating UE DRX Configuration Preference. Here, a binary ‘1’ can indicate that the UE prefers Configuration A and a binary ‘0’ can indicate that the UE prefers Configuration B. However, the meanings of the values of the bit can be reversed in other embodiments.

Furthermore, in one embodiment, PUCCH format ‘1b’ signals can be interpreted by the eNB as indicating UE DRX Configuration Preference. For example, a binary ‘00’ can indicate no SR and a preference for Configuration B. A binary ‘01’ can indicate no SR and a preference for Configuration A. A binary ‘10’ can indicate a SR and a preference for Configuration B. A binary ‘11’ can indicate a SR and a preference for Configuration A.

In addition, in another embodiment, the UE indication for scheduling request (SR) can be combined with the UE DRX Configuration Preference indication using PUCCH format ‘1a’. Here, a binary ‘0’ can indicate that the UE prefers the current DRX configuration to change, while a binary ‘1’ can indicate SR (and a subsequent transition to the DRX On state). No transmission from the UE can indicate that the UE prefers no change in the DRX configuration and no SR.

Furthermore, in some embodiments, PUCCH format ‘2a’ signals can be used by a UE to indicate its DRX Configuration Preference. Here, PUCCH format 2a signals can be interpreted by the eNB as indicating UE DRX Configuration Preference. A binary ‘0’ can indicate a preference for Configuration B and a binary ‘1’ can indicate a preference for Configuration A.

In yet another embodiment, the UE indication for SR can be combined with the UE DRX Configuration Preference indication using a PUCCH format ‘2b’ message. A binary ‘00’ can indicate a preference for Configuration B and an immediate start of the short DRX cycle (Short DRX). A binary ‘01’ can indicate a preference for Configuration B and an immediate start of the long DRX cycle (Long DRX). A binary ‘10’ can indicate a preference for Configuration A and an immediate start of the short DRX cycle (Short DRX). A binary ‘11’ can indicate a preference for Configuration A and an immediate start of the long DRX cycle (Long DRX).

The preceding examples are embodiments of the present disclosure for indicating a DRX Configuration of a UE to a network. These embodiments are examples only and are not intended to be limiting.

A few additional features according to the present disclosure are now described.

In some embodiments, a UE can be prohibited from indicating or sending a DRX Preference indication for some period of time, for instance following a DRX state change or configuration indication. For example, there can be a time interval or window, which can be referred to as a “UE DRX Preference indication prohibit time window” that is specified. During this time window, possibly following a DRX state change or configuration indication, the UE is prohibited from sending a DRX Preference indication. In some embodiments, the UE DRX Preference indication prohibit time window is configured by the network, for example by the eNB or another network element, either through a SIB or through RRC signalling. Furthermore, in some embodiments, UE DRX Preference indication prohibit time window can also be applied after a DRX state or configuration change is effected by the eNB.

Furthermore, in certain embodiments, a UE can be prohibited from sending one or more additional DRX preference indications following having already sent “n” previous indications until a specific time has elapsed. For example, there can be a time window, herein called a “UE DRX Preference indication lockout time window”, that is specified or defined. During this time window following the UE having sent “n” UE DRX preference indications without a response from eNB or network, the UE is prohibited from sending any further preference indications until the UE DRX preference indication lockout time window has elapsed. In some embodiments, the “n” indications can be consecutive previous preference indications. This lockout mechanism can limit the number of times a UE sends a preference indication within a given time period. In addition, this DRX preference indication lockout time window may be larger than the UE DRX preference indication response window discussed above. In some embodiments, the UE DRX Preference indication lockout time window, and the value “n”, are configured by the network, for example by the eNB or another network element, either through a SIB, which may be broadcast by the network, or through RRC signalling.

As described previously, an eNB may reject a DRX Preference indication by not responding to the UE. After the UE DRX Preference indication response window has elapsed, the UE may assume that its DRX state preference has been rejected and may retransmit the preference indication. In some situations, however, the signal containing the DRX Preference indication may be lost in transmission from the UE to the eNB, or the response from the eNB to the UE may be lost due, for example, to transmission errors or interference. In these situations, the UE may not be able to distinguish between a lost transmission, and a rejection of its DRX Preference in the case when the eNB intentionally does not respond. In some embodiments, the eNB may configure a UE with two values of the UE DRX Preference indication prohibit time window and two values of the UE DRX Preference indication lockout time window. One value of each can apply to the cases where a response is not received from the eNB. The other value of each can apply to the cases where the UE explicitly receives a rejection indication from the eNB.

Also, in some embodiments, a UE can provide an indication over a physical channel that it is not imminently expecting data. The UE may use a physical channel such as the PUCCH to send an indication to the network that it does not expect to receive any more data and thus is able or willing to enter a lower-power mode. This is akin to a fast dormancy message in UMTS, but is more efficient because it does not require MAC and RRC messaging. Rather, here this indication can be sent over a physical channel and thus results in less overhead.

The above contemplates that a UE in a communications network may have information that may be useful in making decisions, including control decisions on how the UE interacts and communicates with the network. This information can include details on the current and future behaviour of the UE, including if and when the UE is expecting to transmit and/or receive data. Such information can result in decisions being made that improve one or more various performance metrics of the system, including but not limited to the power efficiency of the UE, and the latency in the system. The useful information in a UE can comprise or be based on information from one or more applications running on the UE.

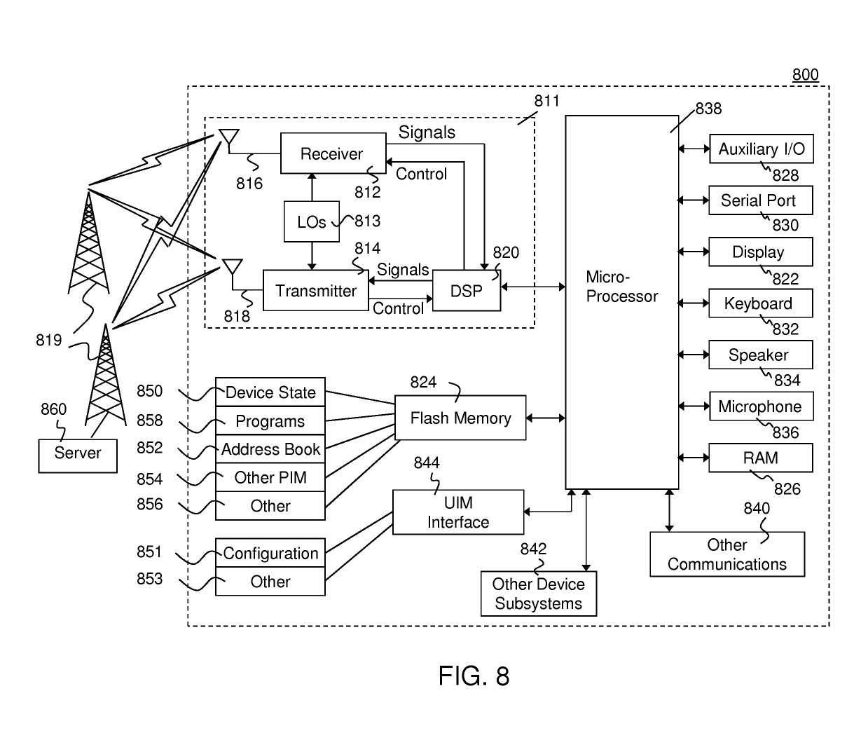

While the above can be implemented on a variety of UEs, mobile or wireless devices, an example of one UE is outlined below with respect to FIG. 8. Reference is now made to FIG. 8.

UE 800 is preferably a two-way wireless communication device having at least voice and data communication capabilities. UE 800 preferably has the capability to communicate with other computer systems on the Internet. Depending on the exact functionality provided, the wireless device may be referred to as a data messaging device, a two-way pager, a wireless e-mail device, a cellular telephone with data messaging capabilities, a wireless Internet appliance, smart phone, tablet computer, or a data communication device, as examples.

Where UE 800 is enabled for two-way communication, it will incorporate a communication subsystem 811, including both a receiver 812 and a transmitter 814, as well as associated components such as one or more, preferably embedded or internal, antenna elements 816 and 818, local oscillators (LOs) 813, and a processing module such as a digital signal processor (DSP) 820. As will be apparent to those skilled in the field of communications, the particular design of the communication subsystem 811 will be dependent upon the communication network in which the device is intended to operate. For example, UE 800 may include a communication subsystem 811 designed to operate within the GPRS network, UMTS network, or an LTE network.

Network access requirements will also vary depending upon the type of network 819. For example, in UMTS and GPRS networks, network access is associated with a subscriber or user of UE 800. For example, a GPRS mobile device therefore requires a subscriber identity module (SIM) card in order to operate on a GPRS network. In UMTS a USIM or SIM module is required. In CDMA a RUIM card or module is required. These will be referred to as a UIM interface herein. Without a valid UIM interface, a mobile device may not be fully functional. Local or non-network communication functions, as well as legally required functions (if any) such as emergency calling, may be available, but mobile device 800 will be unable to carry out any other functions involving communications over the network 800. The UIM interface 844 is normally similar to a card-slot into which a card can be inserted and ejected like a diskette or PCMCIA card. The UIM card can have memory and hold many key configuration 851, and other information 853 such as identification, and subscriber related information.

When required network registration or activation procedures have been completed, UE 800 may send and receive communication signals over the network 819. Signals received by antenna 816 through communication network 819 are input to receiver 812, which may perform such common receiver functions as signal amplification, frequency down conversion, filtering, channel selection and the like, and in the example system shown in FIG. 8, analog to digital (A/D) conversion. A/D conversion of a received signal allows more complex communication functions such as demodulation and decoding to be performed in the DSP 820. In a similar manner, signals to be transmitted are processed, including modulation and encoding for example, by DSP 820 and input to transmitter 814 for digital to analog conversion, frequency up conversion, filtering, amplification and transmission over the communication network 819 via antenna 818. DSP 820 not only processes communication signals, but also provides for receiver and transmitter control. For example, the gains applied to communication signals in receiver 812 and transmitter 814 may be adaptively controlled through automatic gain control algorithms implemented in DSP 820.

Network 819 may further communicate with multiple systems, including a server 860 and other elements (not shown). For example, network 819 may communicate with both an enterprise system and a web client system in order to accommodate various clients with various service levels.

UE 800 typically includes a microprocessor 838, which controls the overall operation of the device. Communication functions, including at least data communications, are performed through communication subsystem 811. Microprocessor 838 also interacts with further device subsystems such as the display 822, flash memory 824, random access memory (RAM) 826, auxiliary input/output (I/O) subsystems 828, serial port 830, keyboard 832, speaker 834, microphone 836, a short-range communications subsystem 840 and any other device subsystems generally designated as 842.

Some of the subsystems shown in FIG. 8 perform communication-related functions, whereas other subsystems may provide “resident” or on-device functions. Notably, some subsystems, such as keyboard 832 and display 822, for example, may be used for both communication-related functions, such as entering a text message for transmission over a communication network, and device-resident functions such as a calculator or task list.

Operating system software used by the microprocessor 838 can be stored in a persistent store such as flash memory 824, which may instead be a read-only memory (ROM) or similar storage element (not shown). Those skilled in the art will appreciate that the operating system, specific device applications, or parts thereof, may be temporarily loaded into a volatile memory such as RAM 826. Received communication signals may also be stored in RAM 826. Further, a unique identifier is also preferably stored in read-only memory, but could alternatively be stored elsewhere.

As shown, flash memory 824 can be segregated into different areas for both computer programs 858 and program data storage 850, 852, 854 and 856. These different storage types indicate that each program can allocate a portion of flash memory 824 for their own data storage requirements. Microprocessor 838, in addition to its operating system functions, can enable execution of software applications on the mobile device. A predetermined set of applications that control basic operations, including at least data and voice communication applications for example, will normally be installed on UE 800 during manufacturing. A software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application would preferably have the ability to send and receive data items, via the wireless network 819. In at least one embodiment, the PIM data items are seamlessly integrated, synchronized and updated, via the wireless network 819, with the mobile device user's corresponding data items stored or associated with a host computer system. Further applications may also be loaded onto the mobile device 800 through the network 819, an auxiliary I/O subsystem 828, serial port 830, short-range communications subsystem 840 or any other suitable subsystem 842, and installed by a user in the RAM 826 or preferably a non-volatile store (not shown) for execution by the microprocessor 838. Such flexibility in application installation increases the functionality of the device and may provide enhanced on-device functions, communication-related functions, or both. For example, secure communication applications may enable electronic commerce functions and other such financial transactions to be performed using the UE 800. These applications will however, according to the above, in many cases need to be approved by a carrier.

In a data communication mode, a received signal such as a text message or web page download will be processed by the communication subsystem 811 and input to the microprocessor 838, which preferably further processes the received signal for output to the display 822, or alternatively to an auxiliary I/O device 828. A user of UE 800 may also compose data items such as email messages for example, using the keyboard 832, which is preferably a complete alphanumeric keyboard or telephone-type keypad, in conjunction with the display 822 and possibly an auxiliary I/O device 828. Such composed items may then be transmitted over a communication network through the communication subsystem 811. Keyboard 832 could also be in the form of a virtual keyboard displayed on display 822 of the UE.

For voice communications, overall operation of UE 800 is similar, except that received signals would preferably be output to a speaker 834 and signals for transmission would be generated by a microphone 836. Alternative voice or audio I/O subsystems, such as a voice message recording subsystem, may also be implemented on UE 800. Although voice or audio signal output is preferably accomplished primarily through the speaker 834, display 822 may also be used to provide an indication of the identity of a calling party, the duration of a voice call, or other voice call related information for example.

Serial port 830 in FIG. 8 would normally be implemented in a personal digital assistant (PDA)-type mobile device for which synchronization with a user's desktop computer (not shown) may be desirable. Such a port 830 would enable a user to set preferences through an external device or software application and would extend the capabilities of mobile device 800 by providing for information or software downloads to UE 800 other than through a wireless communication network. The alternate download path may for example be used to load an encryption key onto the device through a direct and thus reliable and trusted connection to thereby enable secure device communication.

Alternatively, serial port 830 could be used for other communications, and could include as a universal serial bus (USB) port. An interface is associated with serial port 830.

Other communications subsystems 840, such as a short-range communications subsystem, is a further optional component which may provide for communication between UE 800 and different systems or devices, which need not necessarily be similar devices. For example, the subsystem 840 may include an infrared device and associated circuits and components or a Bluetooth™ communication module to provide for communication with similarly enabled systems and devices.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

Moreover, the previous detailed description is provided to enable any person skilled in the art to make or use the present methods and apparatuses. Various modifications to those embodiments will be readily apparent to those skilled in the art, and the generic principles defined herein may be applied to other embodiments without departing from the spirit or scope of the embodiments described herein. Thus, the present case is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed:

1. A method in a user equipment (UE), the method comprising:
generating a power mode state preference to extend or change the current power mode state of the UE; and
indicating to a network element the power mode state preference.

2. The method of claim 1 wherein the generating of the power mode state preference is based at least on a time of an upcoming scheduled power mode state change of the UE.

3. The method of claim 1 further comprising, after the indicating, receiving from the network element a power mode state indication indicating a power mode state for the UE, wherein the power mode state indication indicates one of an acceptance and a rejection of the power mode state preference of the UE.

4. The method of claim 1 further comprising, after the indicating, tracking a response time window in which the UE expects a power mode state indication from the network element indicating a power mode state, and wherein if the UE does not receive the power mode state indication from the network element within the response time window, the UE utilizes the non-response as a rejection of its power mode state preference.

5. The method of claim 1 wherein a power mode state change of the UE involves one of: turning a reception capability of the UE from an On state to an Off state; and turning the reception capability of the UE from an Off state to an On state, wherein the turning of the reception capability of the UE between On and Off states involves turning a receiver of the UE on and off, respectively.

6. The method of claim 1 wherein the power mode state preference of the UE is based on information located on UE comprising at least one of: a status of one or more applications on the UE; whether the UE expects to be receiving or transmitting data from or to a network; a battery energy level of the UE; a value of one or more timers in the UE; a state of an interaction with a user; a current state of a transaction of the UE with a remote communicator; and an estimated round trip time associated with an expected response from a remote communicator.

7. The method of claim 1 wherein the indicating step is performed by a one of: sending a message from the UE to the network element over a physical channel; sending a control element within a medium access control (MAC) message; and sending an information element with a Radio Resource Control (RRC) message from the UE to the network element.

8. The method of claim 1 wherein the UE and the network element are in a Long Term Evolution communications system and wherein the power mode state is a discontinuous reception (DRX) state in a DRX scheme.

9. The method of claim 1 wherein the UE is prohibited from indicating one or more additional power mode state preference indications for the duration of an indication prohibit time window following a power mode state change of the UE, and wherein the indication prohibit time window is configured by the network element through a one of: radio resource configuration (RRC) signalling, and a system information broadcast (SIB) by the network.

10. The method of claim 4 wherein UE is prohibited from indicating one or more additional power mode state preference indications during the response time window.

11. The method of claim 3, wherein the UE is prohibited from indicating one or more additional power mode state preference indications for the duration of a preference indication lockout time window when the UE has not received responses from the network element to a defined number of previous preference indications, wherein the preference indication lockout time window is configured by the network element through a one of: radio resource configuration (RRC) signaling, and a system information broadcast (SIB) by the network element.

12. The method of claim 7 wherein the indicating over a physical channel is performed by way of a physical uplink control channel (PUCCH) message, and wherein the PUCCH message from the UE indicates a preference of the current power mode state of the UE.

13. The method of claim 3 wherein the power mode state indication is received by way of a one of: a control element of a MAC message; an information element of an RRC message; and a physical downlink control channel (PDCCH) in the form of a downlink control information (DCI).

14. A user equipment (UE) comprising:
a communications subsystem adapted communicate with a network;
memory; and
a processor
wherein the user equipment is configured to:
generate a power mode state preference to extend or change the current power mode state of the UE; and
indicate to a network element the power mode state preference.

15. The user equipment of claim 14 wherein the generating of the power mode state preference is based at least on a time of an upcoming scheduled power mode state change of the UE.

16. The user equipment of claim 14, wherein the user equipment is further configured to receive from the network element a power mode state indication indicating a power mode state for the UE based at least on the power mode preference of the UE, and wherein the power mode state indication indicates one of an acceptance and a rejection of the power mode state preference of the UE.

17. The user equipment of claim 14 wherein the user equipment is further configured to track a response time window in which the UE expects a power mode state indication from the network element indicating a power mode state based at least on the power mode state preference of the UE, and wherein if the UE does not receive the power mode state indication from the network element within the response time window, the UE interprets the non-response as a rejection of its power mode state preference.

18. The user equipment of claim 14 wherein a power mode state change of the UE involves one of: turning a reception capability of the UE from an On state to an Off state; and turning the reception capability of the UE from an Off state to an On state, wherein the turning of the reception capability of the UE between On and Off states involves turning a receiver of the UE on and off, respectively.

19. The user equipment of claim 14 wherein the power mode state preference of the UE is based on information located on UE, comprising at least one of: a status of one or more applications on the UE; whether the UE expects to be receiving data from a network; a battery energy level of the UE; a value of one or more timers in the UE; a state of an interaction with a user; a current state of a transaction of the UE with a remote communicator; and an estimated round trip time associated with an expected response from a remote communicator.

20. The user equipment of claim 14 wherein the user equipment is further configured to indicate by a one of: sending a message from the UE to the network element over a physical channel; sending a control element within a medium access control (MAC) message; and sending an information element with a Radio Resource Control (RRC) message from the UE to the network element.

21. The user equipment of claim 14 wherein the UE and the network element are in a Long Term Evolution communications system and wherein the power mode state is a discontinuous reception (DRX) state in a DRX scheme.

22. The user equipment of claim 14 wherein the UE is prohibited from indicating one or more additional power mode state preference indications for the duration of an indication prohibit time window following a power mode state change of the UE, wherein the indication prohibit time window is configured by the network element through a one of: radio resource configuration (RRC) signalling, and a system information broadcast (SIB) by the network.

23. The user equipment of claim 17 wherein UE is prohibited from indicating one or more additional power mode state preference indications during the response time window.

24. The user equipment of claim 16, wherein the UE is prohibited from indicating one or more additional power mode state preference indications for the duration of a preference indication lockout time window when the UE has not received responses from the network element to a defined number of previous consecutive preference indications, wherein the preference indication lockout time window is configured by the network element through a one of: radio resource configuration (RRC) signalling, and a system information broadcast (SIB) by the network element.

25. The user equipment of claim 20 wherein the user equipment is further configured to indicate by way of a physical uplink control channel (PUCCH) message, and wherein the PUCCH message from the UE indicates a preference of the current power mode state of the UE.

26. The user equipment of claim 16 wherein the power mode state indication is received by way of a one of: a control element of a MAC message; an information element of an RRC message; and a physical downlink control channel (PDCCH) in the form of a downlink control information (DCI).

27. A method in a network element, the method comprising:
receiving from a user equipment (UE) a power mode state preference to extend or change the current power mode state of the UE;
generating a power mode state indication for the UE; and
indicating to the UE the power mode state indication.

28. A network element comprising:
a communications subsystem adapted to receive a power mode state preference of a user equipment (UE) to extend or change the current power mode state of the UE;
memory; and
a processor,
wherein the network element is configured to:
receive from a user equipment (UE) a power mode state preference to extend or change the current power mode state of the UE;
generate a power mode state indication for the UE; and
indicate to the UE the power mode state indication.
